(19) United States
(12) Patent Application Publication
(10) Pub. No.: US 2011/0035352 A1
(43) Pub. Date: Feb. 10, 2011

(54) System and Method for Processing Radiological Information Utilizing Radiological Domain Ontology

(76) Inventors: Charles R. Hale, Trumbull, CT (US); Donald E. Salz, New Rochelle, NY (US); Yihong Ding, Westport, CT (US)

Correspondence Address: Woods Oviatt Gilman LLP, 700 Crossroads Bldg, 2 State St., Rochester, NY, 14614, US

(21) Appl. No.: 12/535,825

(22) Filed: Aug. 5, 2009

(51) Int. Cl. G06N 5/02

(52) U.S. Cl. 706/54

(57) ABSTRACT

The present invention is directed in general to a system and method that employs radiological domain ontology to specify and model radiological information as knowledge. A system and method are provided that allow for consulting the ontology in the context of the model that the ontology fulfills. The result of consulting the ontology is validated, identified and classified radiological information that is based on information provided in the consultation.

### TECHNICAL FIELD

The present invention is directed in general to imaging technologies and more particularly to medical imaging and Picture Archiving and Communication Systems (PACS) having an image display wherein the identification, validation and classification of radiological information is desired. A system and method are provided to define various aspects of radiological information processing as concept properties represented by a vocabulary of one or more instances of ontology concepts. Even further, a system and method are provided for consulting a radiological ontology whereby radiological information is modeled as knowledge and radiological image observations can be identified, validated and classified in a consistent manner. Users are able to quickly, accurately and consistently reference and report radiological observations.

### BACKGROUND OF THE INVENTION

In medical imaging, Picture Archiving and Communication Systems (PACS) are a combination of computers and/or networks dedicated to the storage, retrieval, presentation and distribution of images. While images may be stored in a variety of formats, the most common format for image storage is Digital Imaging and Communications in Medicine (DICOM). DICOM is a standard in which radiographic images and associated meta-data are communicated to the PACS system from imaging modalities for interaction by end-user medical personnel.

Medical personnel spend a significant amount of their time addressing administrative tasks. Such tasks include, for example, documenting patient interaction and treatment plans, preparing billing, reviewing lab results, recording observations and preparing reports for health insurance. Time spent on performing such tasks diminish the time available for patients and in some instances lead to inaccurate and hastily compiled reports or records when personnel are faced with the need to see multiple patients.

In order to address time deficiency issues, the current trend in the medical field is to automate as many health care related processes as possible by leveraging various technologies, and thereby freeing up personnel to spend more time with patients rather than performing administrative tasks. Another objective in this arena is to ensure that administrative tasks are accomplished in an accurate and consistent manner. One approach to achieving this objective is to provide a standardized representation for healthcare related data particularly within the various specialty areas, such as radiology, cardiology, etc.

Health care data is not easily reusable by disparate groups in the radiological field because it is stored with different methods and in different formats across a wide range of information technology. Various initiatives by groups and organizations across the globe, including the National Institutes of Health, Food and Drug Administration, and other medical bodies, have driven a set of standards for the consolidation of medical information into a common framework. One such standard is RadLex, which is a standard radiological lexicon proposed by the Radiological Society of North America, for uniform indexing and retrieval of radiology information. RadLex is a taxonomy having class hierarchies. It functions essentially as a dictionary of terms and the relationships among the terms. RadLex has some crucial limitations. The most significant of these limitations being the inability to support radiological findings and the relationships between findings and characteristics of the findings. What is needed is an extension to RadLex—an extension that provides domain specific modeling, which can then be applied to or utilized by a wide variety of applications such as, report tools, treatment analysis programs, tools for classification and verification of radiological information, and systems for improving radiological work flow. Such an extension would utilize an ontology that is domain specific in order to process radiological information.

Ontology is a data model for the modeling of the concepts and the relationship between a set of concepts. Ontologies are utilized to illustrate the interaction between the set of concepts and corresponding relationships within a specific domain of interest. Thus, the concepts and the relationships between the concepts can be represented in readable-text, wherein descriptions are provided to describe the concepts within a specific domain and the relationship axioms that constrain the interpretation of the domain specific concepts.

Numerous current products and research efforts offer tools that streamline data integration. These include centralized database projects such as, the Functional Magnetic Resonance Imaging Data Center and the Protein Data Bank, distributed data collaboration networks such as the Biomedical Informatics Research Network, commercial tools for data organization, and systems for aggregating healthcare information such as Oracle Healthcare Transaction Base. In addition, tools have been developed to automatically validate data integrated into a common framework. Validation calls for techniques such as declarative interfaces between the ontology and the data source and Bayesian reasoning to incorporate prior expert knowledge about the reliability of each source.

Automated data integration and validation require fewer human resources, but necessitates that data have well-defined a priori structure and meaning. The most successful approaches make use of a standardized master ontology that provides a framework to organize input data, as well as a technology scheme for augmenting and updating the existing ontology. This paradigm has been successfully applied in various ontologies including Biodynamic Ontology, Gene Ontology, Mouse Gene Database, and the Mouse Gene projects, which provide a taxonomy of concepts and their attributes for annotating gene products. The Unified Medical Language System (UMLS) Metathesaurus and Semantic Network, combines multiple emerging standards to provide a standardized ontology of medical terms and their relationships

Ontology is a philosophy of what exists. In computer science ontology is used to model entities of the real world and the relations between them to create common dictionaries for their discussion. Basic concepts of ontology include (i) classes of instances/things, and (ii) relations between the classes, as described herein below. Ontology provides a vocabulary for talking about things that exist.

Relations, also referred to as properties, attributes and functions are specific associations of things with other things. Relations can include:

Relations between things that are part of each other, e.g., between a car and its tires;

Relations between things that are related through a process such as the process of creating the things, e.g., a painter and his/her painting; and

Relations between things and their measures, e.g., a tumorous mass and its size.

Some relations also associate things to fundamental concepts such as size, which would be related to large or small, or morphology which would be related to the shape of a mass such as round or linear.

Relations play a dual role in ontology. In one instance, individual things are referenced by way of properties, e.g., a person by a name or characteristic, or music by its title and author. In another instance, knowledge being shared is often a property of things too. A thing can be specified by some of its properties, in order to query for the values of its other properties.

Not all relations are relevant to all things. It is convenient to discuss the domain of a relation as a “class” of things, also referred to as a category. Often domains of several relations may coincide.

There is flexibility in the granularity to which classes are defined. Assume automobile is a class. Ford cars may also be a class, with a restricted value of a brand property. However, this would only be a logical definition if Ford cars had attributes that were of interest or common to other automobiles. Generally, one can define classes as granular as an individual automobile unit, although an objective of ontology is to define classes that have important attributes.

There are a number of functionalities not provided by the systems described earlier. Accordingly, there is a need for a comprehensive system which is capable of enabling researchers to: i) efficiently enter heterogeneous local data into the framework of the UMLS-based ontology, ii) make necessary extensions to the standardized ontology to accommodate their local data, iii) validate the integrated data using expert rules and statistical models defined on data classes of the standardized ontology, iv) efficiently upgrade data that fails validation, and v) leverage the integrated data for clinical outcome predictions. This is particularly the case in the field of radiology and even more specifically within the various domains therein, such as mammography.

To overcome some of the deficiencies earlier described, some existing systems have attempted to minimize the amount of effort that may be required to report on radiological findings. However, these systems suffer from a myriad of drawbacks. Essentially these solutions have: non standard library or vocabulary; no error, terminology or consistency checking; and no collaboration or tool that can be used by other application programs.

The shortcomings of the prior art are overcome and additional advantages are provided through the provision of a method for utilizing ontology that is based upon data obtained from unstructured and semi-structured knowledge sources to provide identification, validation and classification of radiological concepts.

The present invention fulfills these needs as well as other needs.

### SUMMARY OF THE INVENTION

The present invention is directed in general to a system and method that employs radiological domain ontology to specify and model radiological information as knowledge. The present invention provides a methodology to consult the domain ontology and provide information in reference to a subject, report or images that may be specific to one or more than one modality. The method comprises defining one or more aspects of radiology functions as concept properties represented by a vocabulary of one or more instances of the radiological domain ontology.

The radiological domain ontology declares and fulfills a model of radiological domain knowledge by employing a context that defines a set of domain knowledge and the relationships among said set of domain knowledge with respect to imaging modalities when necessary or appropriate. In other words, this ontology can contain information that is non-modality specific. The invention validates that an information item of interest relating to said subject or imaging modalities is radiological in nature and resides in the domain knowledge. The invention further identifies a definitive concept of said information item from within said domain of knowledge and classifies the information item as a finding or finding characteristic that has object properties. The object properties represent relationships among said findings and finding characteristics.

Exemplary embodiments of the present invention relate to a solution for the extraction of information from unstructured knowledge sources of radiological information, for example a string of text or radiological information provided in any order. Further, ontological relationships are inferred between the extracted information. The inferred ontological relationships are identified, verified and classified.

### BRIEF DESCRIPTION OF THE DRAWINGS

The above-mentioned features and other features and advantages of this invention, and the manner of attaining them, will become apparent and be better understood by reference to the following description of the invention in conjunction with the accompanying drawing, wherein:

FIG. 1 is an illustrative block diagram of a radiological knowledge domain applicable to an image on a user interface for which there are a plurality of attributes associated with findings in the image;

FIG. 2 is an illustrative diagram of instance of ontology concepts that represent a vocabulary for expressing the concepts of FIG. 1;

FIG. 3 is a data and flow diagram of an exemplary process for validating radiological information;

FIG. 4 is data and flow diagram of an exemplary process for validating that a given radiological information is within a given radiological context;

FIG. 5A is a data and flow diagram for producing in a client program, a listing request of findings for a domain modeled in the ontology of FIG. 1;

FIG. 5B is a data and flow diagram for producing in a client program, a listing request of characteristics for a domain modeled in the ontology of FIG. 1;

FIG. 5C is a data and flow diagram for producing in a client program, a listing request of characteristics in context for a domain modeled in the ontology of FIG. 1;

FIG. 6 is a data and flow diagram for editing i.e. addition/deletion, of an instance of a given radiological informational item G concept, to/from the radiological domain ontology;

FIG. 7 is a data and flow illustration for providing a list of individual radiological finding related characteristic concepts and finding characteristic individuals for a valid image finding I, in the modeled ontology; and

FIG. 8 is a block diagram generally illustrating a computing environment in which the invention may be implemented.

### DETAILED DESCRIPTION OF A PREFERRED EMBODIMENT

Generally, the system and methods described herein may be implemented in hardware, software or a combination thereof. The disclosed embodiments are intended to be illustrative since numerous modifications and variations thereof will be apparent to those of ordinary skill in the art.

This document is organized as follows. In the first section, an overview of the techniques and implementation necessary to provide a consistency of terminology in radiological consulting and reporting in accordance with the present invention are provided and described. In the next section, an exemplary implementation of particular features of the present invention for modeling radiological information as knowledge is discussed. Following this, other aspects of the invention as they pertain to use and function of the invention are discussed. Finally, an exemplary computer environment for the implementation and use of the invention is described.

The present invention employs radiological domain ontology to specify and model radiological information as knowledge. A system and method are provided to allow for consulting the ontology in the context of the model the ontology fulfills. Consulting the ontology results in identified, validated and classified radiological information that is based on the information provided in the consultation.

More specifically, the present invention also relates to a solution for the extraction of information from an unstructured knowledge source. A set of subject-matter specific relationships are established as a logical foundation for the ontological subject matter domain. The subject-matter specific relationships can be derived partially from a pre-existing information source (e.g., RadLex the radiological lexicon) and partially from the knowledge that needs to be modeled for an identified subject. For example, ontology on the subject of mammography will use lumps or masses as topic concepts. The relationships may correspond to disease-specific relationships such as biopsy, additional exam, symptoms, location, further treatments, etc. Once the subject-matter specific relationships have been established, the unstructured knowledge source is parsed in order to identify topic headings and content text that is associated with respective topic headings within the unstructured knowledge source. The context texts that are identified within the unstructured knowledge source correspond to the predetermined subject-matter specific relationship. It should be understood that the source of the unstructured information is varied and includes such sources as spoken words, a users typing, reports or systems or applications that need to determine if a piece of information is radiological.

The textual content (finding) is then analyzed to identify references to concepts—wherein concept reference descriptors (finding characteristics) can be obtained and presented to a system user or to other down line applications or systems. For each concept reference descriptor that is identified, an analysis is performed of relevant textual content information to identify references to concept descriptors that exist within the textual content information.

The present invention utilizes ontology to define a set of knowledge and relationships among the knowledge thereby employing a context. For example, if there is a finding of a tumorous mass in an image, the system knows what other information would be relevant to that finding such as, size, density, location and other characteristics that apply to that finding, as well as, the relationships between the findings and finding characteristics.

Ontological models are used to talk about “things.” An important vocabulary tool is “relations” between things. An ontology model itself does not include the “things,” but introduces classes and relations, which can then be used as a vocabulary for talking about and classifying things. In the field of medicine, ontology is used in solving problems in the field of medical terminology including the organization of copious amounts of data, the alignment and integration of heterogeneous knowledge and disambiguates in terminology.

The present invention provides a combination of an intelligent database and system, which can provide not only stored information but also information which can be determined by knowledge of the technical domain.

In an embodiment of the present invention, the Radiological domain ontology is constructed using combinations of one or more of the following World Wide Web Consortium standards:
RDF—Resource Description Framework
RDFS—RDF Schema
OWLDL—Web Ontology Language Description Logic version

Although the following discussions and the present invention are described in relation to a biological imaging system, it should be understood that the invention is also applicable to other information/imaging technologies, systems or text reports Imaging systems as discussed herein, include those wherein image manipulation, image attributes, and features of an imaging system are required to be intuitively and easily analyzed and/or reported, including non-medical systems, visual analysis and diagnostic tools, and other visual user interface environments. Further, the present invention is described with reference to mammography and particular imaging modalities. However, the system and method of the present invention is equally applicable to other radiological domains and imaging modalities. Additionally, this specification describes and references reporting for illustrative purposes only. The use in other applications or by other systems or tools are anticipated and within the scope of the present invention.

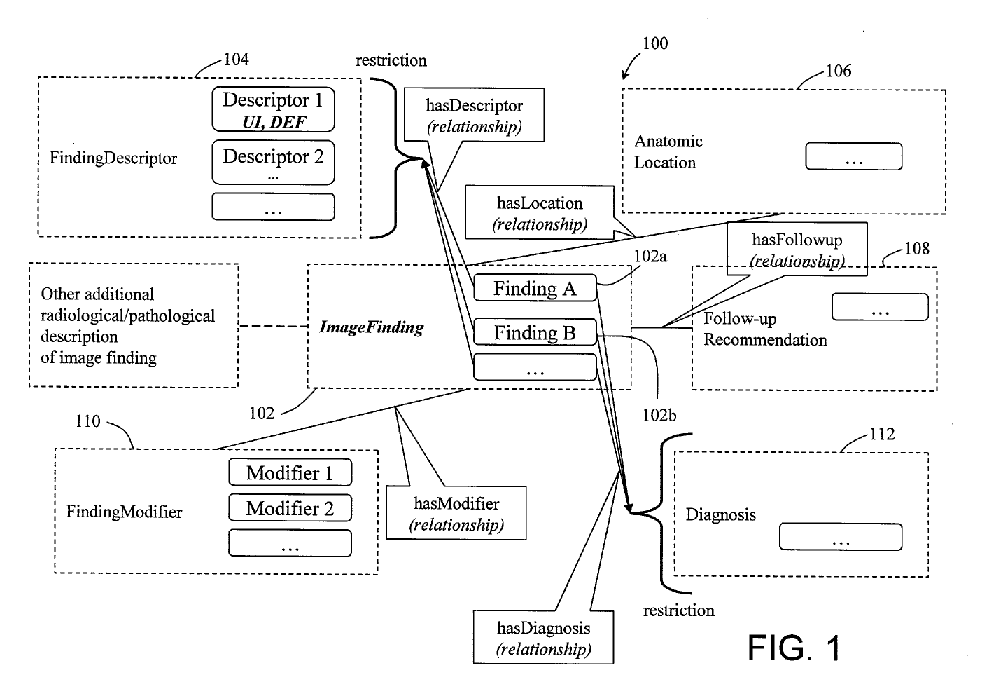

An ontology on the subject of radiology in general or mammography specifically, may use findings and finding characteristics as topic concepts while the relationships may correspond to disease-specific relationships. In an embodiment of the present invention, a radiological domain ontology that both declares and fulfills a model of radiological domain knowledge may be described as shown in FIG. 1.

Referring initially to FIG. 1, pathological, physiological and iatrogenic entities and pathological, physiological and iatrogenic observations may be modeled conceptually as radiological findings. Therefore, in connection with a particular image that is being observed or considered by a radiologist, there may be a number of findings 102a, 102b collectively referenced as findings 102. Associated with the findings 102 are a number of descriptors 104, thereby defining a relationship expressed as an object property—“has Descriptor” for the relevant findings 102.

Attributes within the realm of radiological knowledge including diagnosis, anatomic location, and follow-up recommendation, of pathological, physiological, and iatrogenic entities and pathological, physiological, and iatrogenic observations may be modeled conceptually as radiological finding characteristics. Whereby, a particular one of the findings 102 may be associated with an anatomic location 106 as a finding characteristic with a relationship and object property—“has Location” for said particular one of the findings 102. Further, there may be a follow-up recommendation 108 for any one or more of the findings, which would result in a relationship—“has Followup.” Even further, findings 102 may also be associated with a diagnosis 112 having a restrictive relationship—“has Diagnosis.” Further still, there may also be finding modifiers 110, with resulting relationship—“has Modifier.” The relationships between pathological, physiological, and iatrogenic entities/observations and radiological finding characteristics may therefore be modeled as object properties i.e. “has Location;” “has Followup;” “has Diagnosis.”

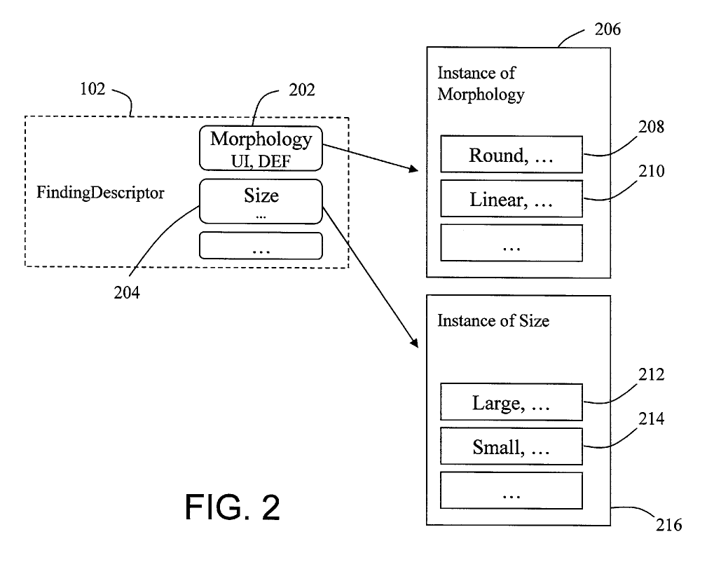

The modeled ontology may further contain constraints on radiological findings, radiological finding characteristics, and relationships. Further still, the ontology may also contain concept properties, such as applicability to a user interface or application localization, i.e., language indication. It should be understood that certain concepts may be defining concepts from which individual instances may be utilized to represent the vocabulary representing the concept. This aspect is best illustrated with reference to FIG. 2.

As shown in FIGS. 1 and 2, finding descriptor 104 may include the concept of morphology 202, and size 204. Any of these concepts may be a defining concept from which an instance may be derived to further represent or further describe a finding or finding characteristic. As illustrated, morphology 202 may have a morphology instance 206, characterized by further descriptions or qualifiers such as round 208, linear 210 and so forth. Similarly, size 204 may have a size instance 212 characterized by further descriptions or qualifiers such as Large 214, small 216, etc.

Accordingly, these concept instances can be utilized as the vocabulary for describing finding 102. Even further, the concept instances 206,216 provide a vocabulary guide in the sense that a radiologist can pick only one of the provided descriptions 208,210,212,214 from within each of the relevant instances, e.g., round or linear in the case of morphology. As such an individual radiologist or system utilizing the ontology cannot describe a mass for example as being both linear 210 and round 208; or the size of a mass as being both large 212 and small 214. The system thereby incorporates error, terminology and consistency checking. In a further embodiment of the present invention, the vocabulary guide allows a selection of more than one described invention, wherein the number of allowable selections is governed by the cardinality of the relationship between the finding and the relevant characteristic. Accordingly, the previously described concept instances 206, 216 provide a cardinality of “max 1”.

In order to facilitate reference and identification of the parts of an image for the purpose of diagnosis or analysis of the subject, the various parts of the image may need to be identified and commented or reported upon. The present invention provides a system and method for consulting the radiological domain ontology earlier described, for validation, identification and classification.

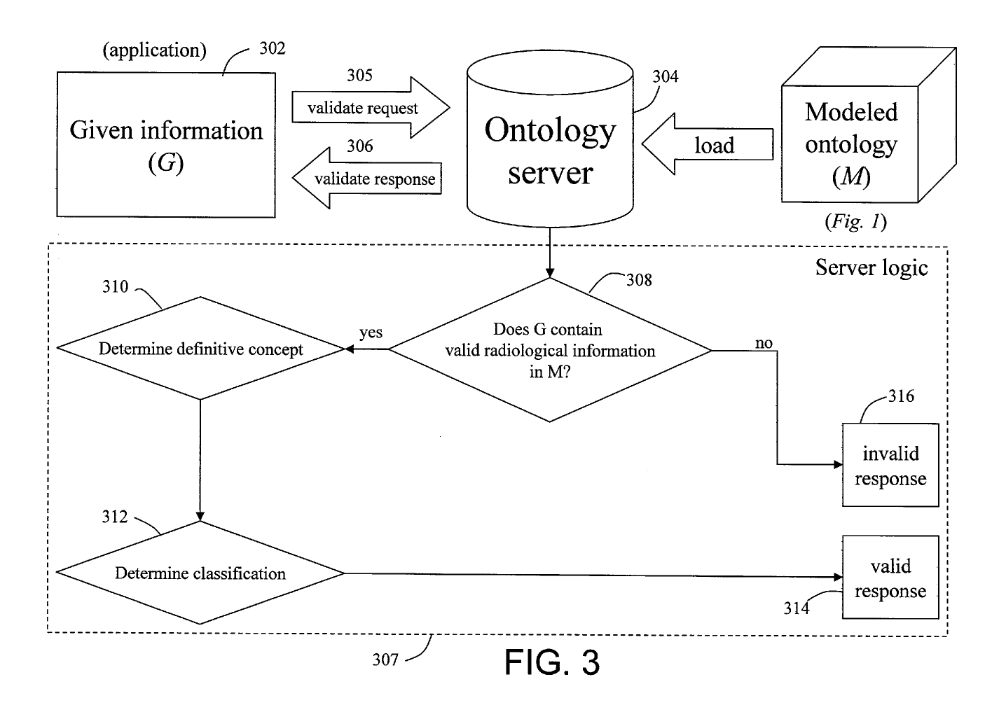

For example, and as illustrated in FIG. 3, an application program 302 having a given information G, initiates a validation request 305 to an ontology server 304. The ontology server 304 is loaded with a modeled ontology M of the present invention, such as described by FIG. 1. Program/server logic 307, which may reside on the ontology server 304 as shown or reside on another device having access to the ontology server 304, accepts the validation request 305 and provides a validation response 306. In operation, logic 307 determines at step 308, if the given information G contains valid radiological information in the modeled ontology M. If valid information is contained therein, identification of a definitive concept that resides in the domain is determined at step 310. Classification of the given information G as a finding or a finding characteristic within the domain, is determined at step 312. Following this, a valid response indication 314, is provided in the validation response 306. In the event that the given information G was not valid radiological information in M as determined at step 308, an invalid response indication 316, is provided in the validation response 306.

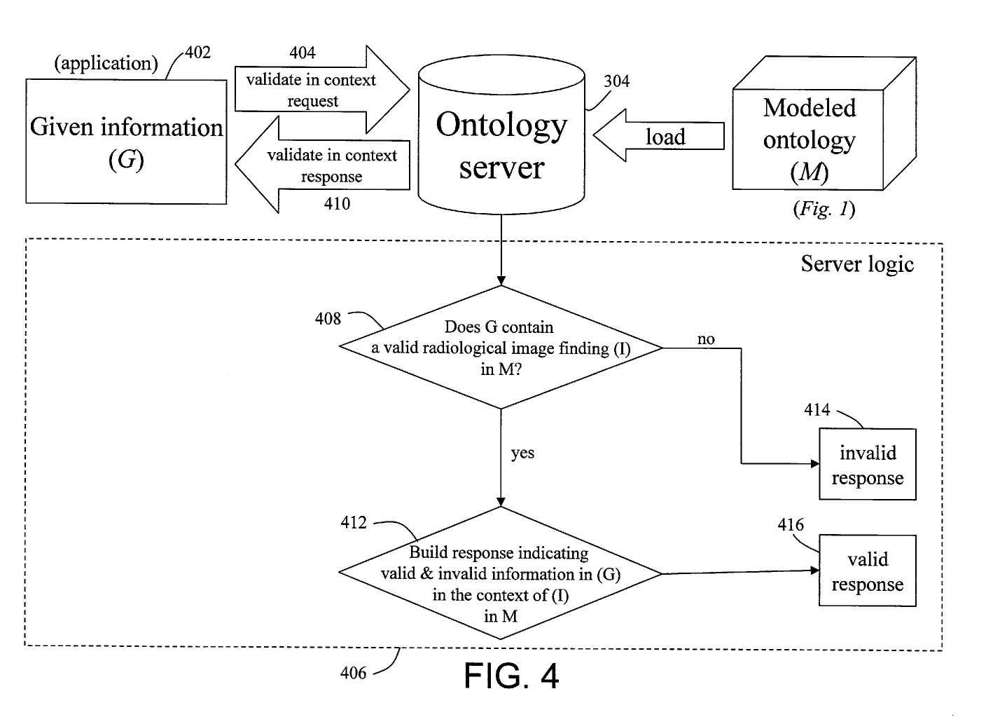

The given information G is also evaluated by the present invention to determine if the information G is in context. As shown in FIG. 4, a validate in context request 404 is initiated from application program 402 to the ontology server 304. In operation, program/server logic 406, determines if G contains a valid radiological image finding I within the modeled ontology M, at step 408. If the result of that inquiry is dispositive then an invalid response signal 414 is conveyed to validate in context response 410 and back to the application program 402. Conversely, if the result of the inquiry is affirmative, a response indicating that the given information G is valid in the context of the ontology M, a valid response signal 416 is built at step 412 and then sent back to the application program 402.

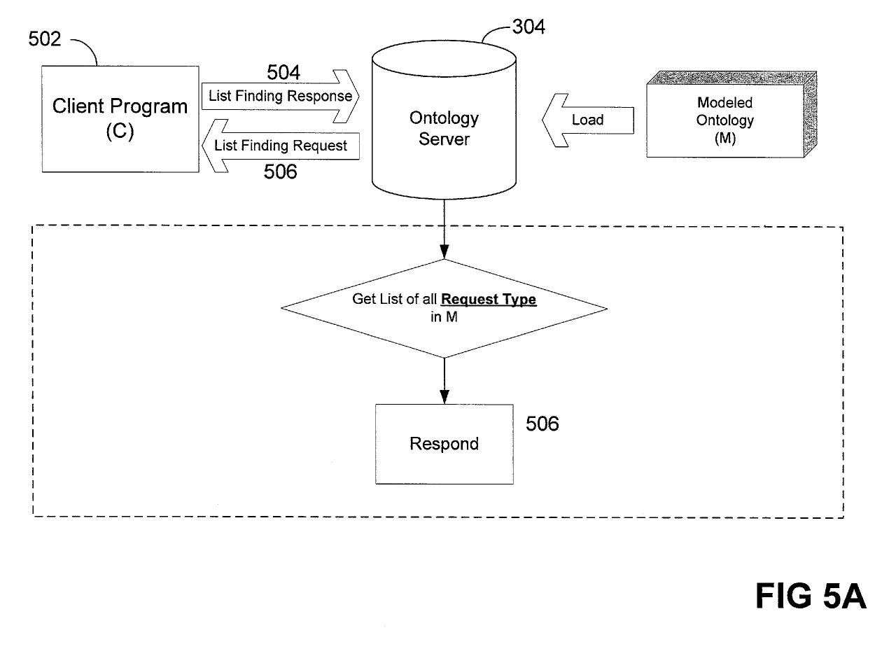

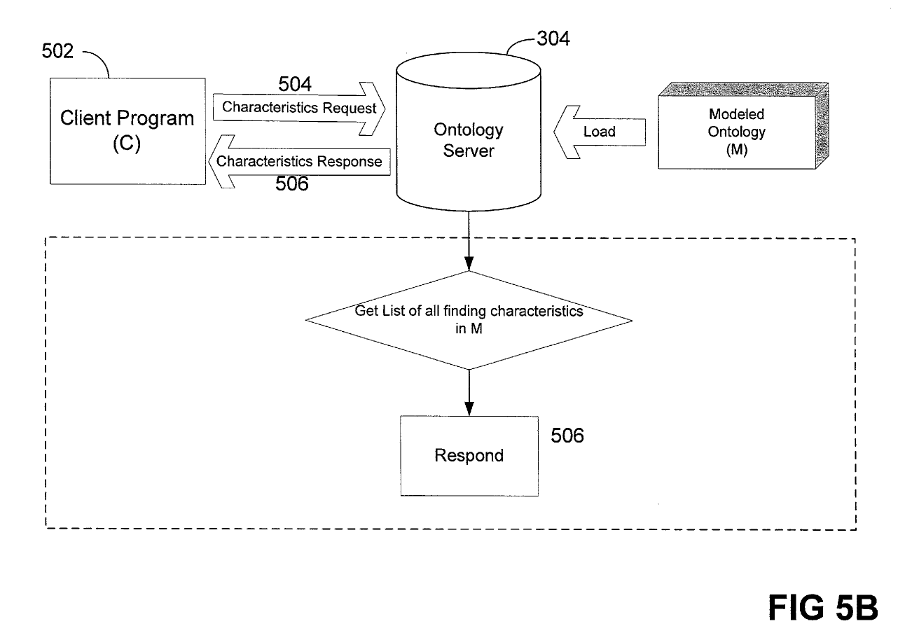

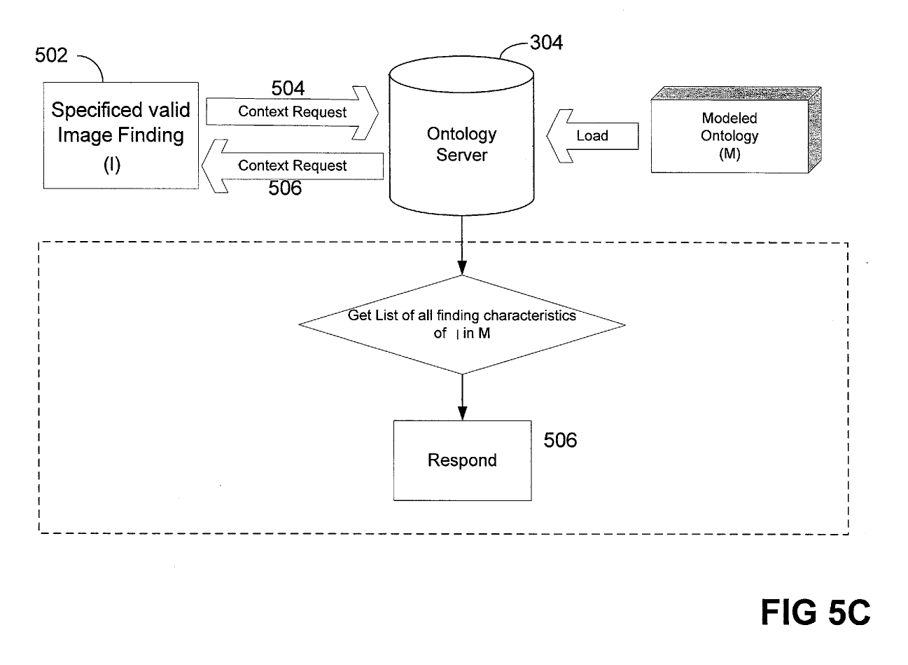

In another aspect of the present invention, a client program C executing in an application 502, may initiate a list request 504 to the ontology server 304 for any one of a variety of information types for the domain type modeled in the ontology. The information types may include a list of radiological findings for the domain (shown in FIG. 5A); a list of all radiological finding characteristics for the domain (shown in FIG. 5B); or a list of all radiological finding characteristics that apply to a given radiological finding in the domain (shown in FIG. 5C). In each case, a list response 506 is provided back to the client program C.

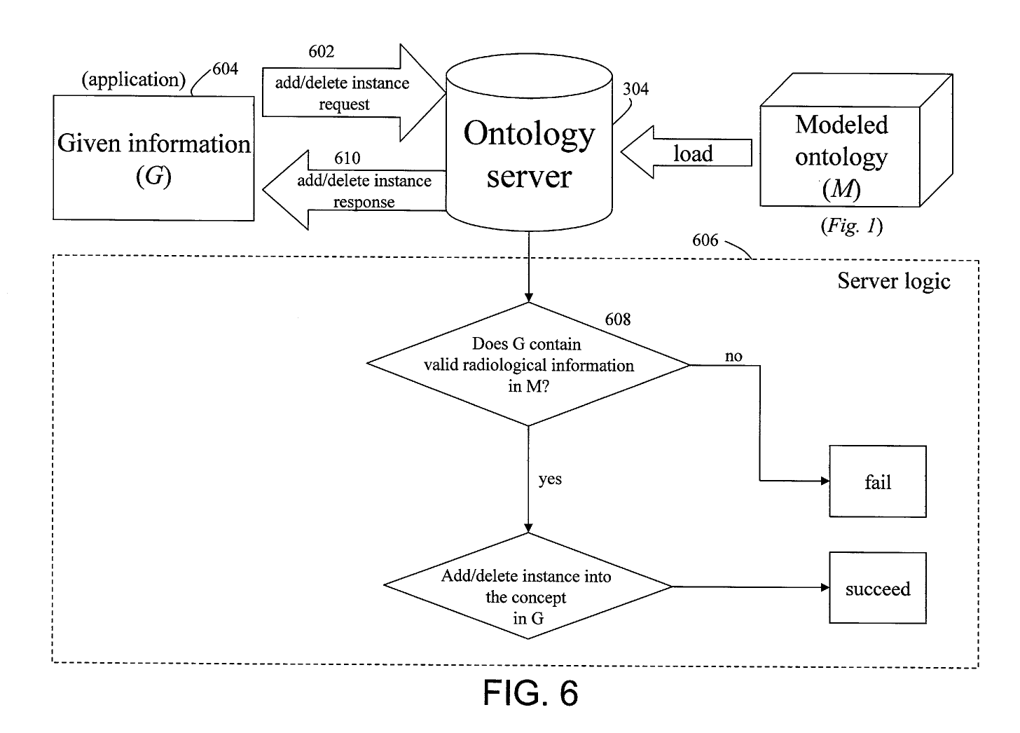

In a further aspect of the present invention, and as illustrated in FIG. 6, a given information concept G may be added or deleted as an instance of a radiological finding concept depending on whether or not such concept contains valid radiological information within the modeled ontology M. In operation, an add/delete instance request 602 is initiated by an application 604 for a given concept G. Program/server logic 606 determines if G contains valid radiological information in M, at step 608. If the result of that determination is false, then a fail signal is returned in the add/delete instance response 610, to the initiating application 604. Conversely, if the result of the determination is true, then the appropriate action, i.e., addition or deletion, of the given information G as an instance of a radiological finding concept is performed. A similar operation is also provided for instance expressions in the radiological domain ontology.

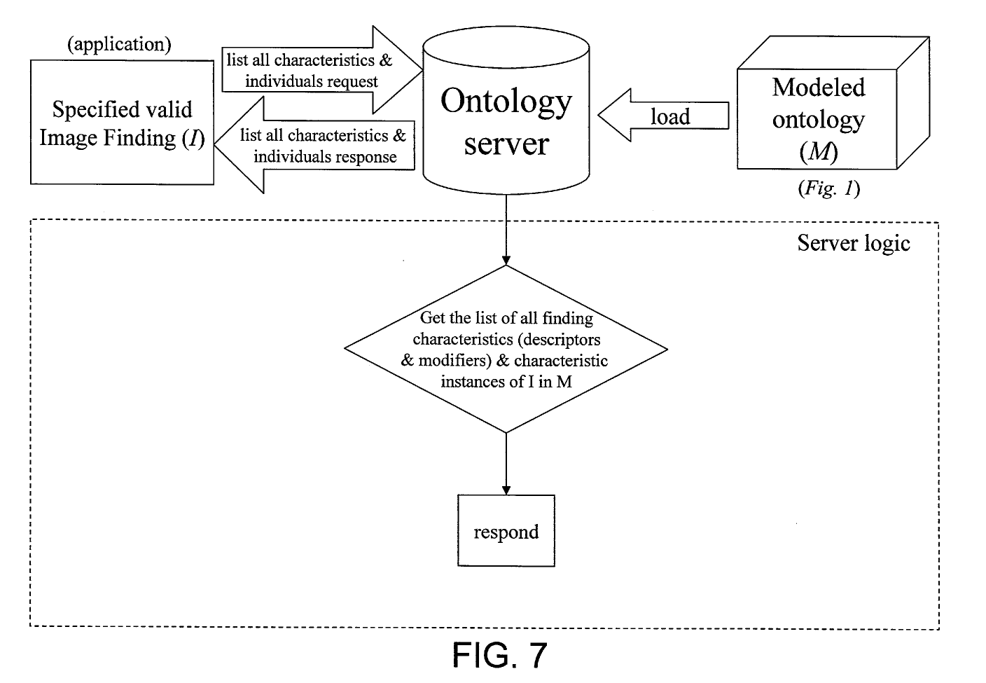

In an even further aspect, the present invention provides that for a specified valid image finding I, the modeled ontology may be queried for all finding characteristics, i.e., descriptions and modifiers, as well as, characteristic instances of the finding F, in the modeled ontology. This feature is illustrated in FIG. 7.

To further illustrate an application of the various features and aspects of the invention, an implementation example of the above described invention is next described. In this implementation example, a radiological ontology for mammography is utilized.

The first thing that is done by the system and method of the present invention is to model the mammography information in the manner described earlier herein. That is to say that the knowledge of the mammography ontology is modeled as findings, finding characteristics, and object properties/relationships, with constraints in the mammography. Concepts properties are then defined for the domain.

The second thing is to provide a system and methodology for consulting the ontology in the form of independent software that can be utilized by other software or applications. Turning now to the specific process, a third party application receives three pieces of purported mammography radiological information describing a mammography radiological finding and its mammography radiological finding characteristics.

Using the system and methods described herein, the application consults the domain ontology about each piece of purported mammography radiological information to receive validation that it is mammography radiological information. The application also receives the identity of the information and the classification for the sought after information.

The application examines the classification of each piece of information and if one informational item is classified as a mammography radiological finding then the ontology is consulted in the context of the mammography radiological finding, and the remaining information is revalidated, i.e., do the radiological finding characteristics apply to that radiological finding?

These steps result in providing radiological information that has been validated, identified and classified in the mammography domain ontology to the third party application.

Radiology, which includes a variety of imaging modalities such as, X-ray, Projected X-ray and MRI, comprises of approximately 65 findings plus several hundred characteristics. In the area of mammography, there are approximately fifteen specific findings in addition to the applicable characteristics for those findings. The present invention, while described in the domain of mammography, is applicable to any domain ontology in the field of radiology.

Having described the system and method of the present invention and an embodiment thereof, an exemplary computer environment for implementing the described design and execution is presented next.

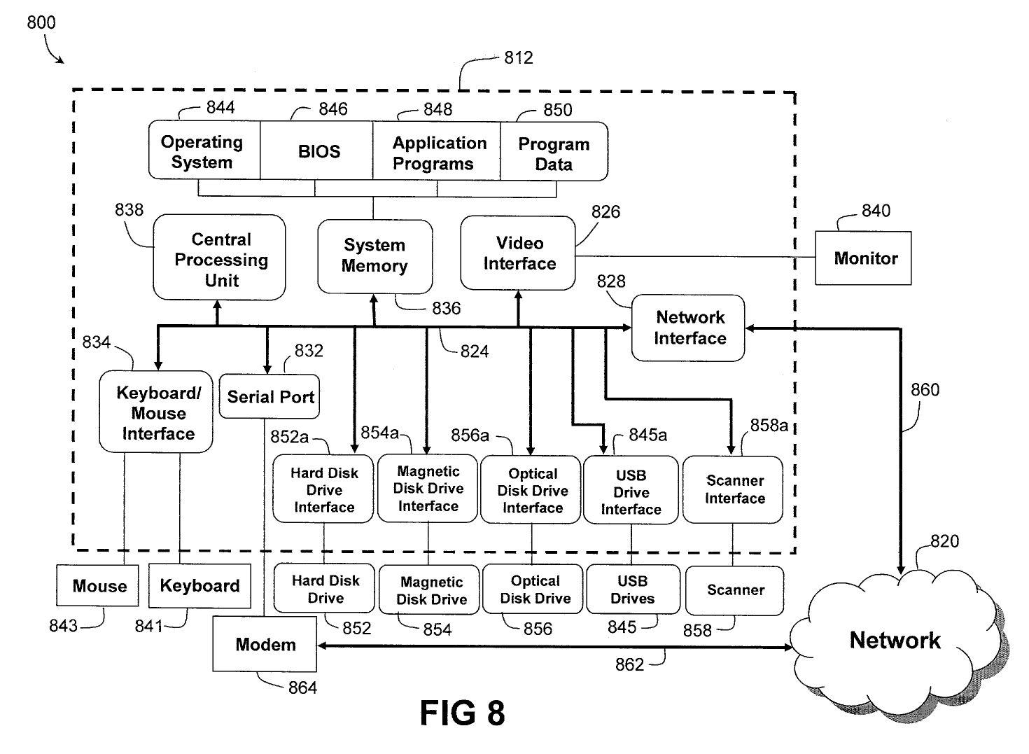

FIG. 8 shows an exemplary computing environment 800 that can be used to implement any of the processing thus far described. Remote computer 812 may be a personal computer including a system bus 824 that couples a video interface 826, network interface 828, one or more serial ports 832, a keyboard/mouse interface 834, and a system memory 836 to a Central Processing Unit (CPU) 838. Remote computer 812 may also include a Graphics Processing Unit (GPU) or one or more other special or general purpose processing units. A monitor or display 840 is connected to bus 824 by video interface 826 and provides the user with a graphical user interface to view, edit, and otherwise manipulate digital images. The graphical user interface allows the user to enter commands and information into remote computer 812 using a keyboard 841 and a user interface selection device 843, such as a mouse or other pointing device. Keyboard 841 and user interface selection device are connected to bus 824 through keyboard/mouse interface 834. The display 840 and user interface selection device 843 are used in combination to form the graphical user interface which allows the user to implement at least a portion of the present invention. Other peripheral devices may be connected to remote computer 812 through serial port 832 or universal serial bus (USB) drives 845 to transfer information to and from remote computer 812. For example, CT scanners, X-ray devices and the like may be connected to remote computer 812 through serial port 832 or USB drives 845 so that data representative of a digitally represented still image or video may be downloaded to system memory 836 or another memory storage device associated with remote computer 812 to enable processes and functions in accordance with the present invention.

The system memory 836 is also connected to bus 824 and may include read only memory (ROM), random access memory (RAM), an operating system 844, a basic input/output system (BIOS) 846, application programs 848 and program data 850. The remote computer 812 may further include a hard disk drive 852 for reading from and writing to a hard disk, a magnetic disk drive 854 for reading from and writing to a removable magnetic disk (e.g., floppy disk), and an optical disk drive 856 for reading from and writing to a removable optical disk (e.g., CD ROM or other optical media). The remote computer 812 may also include USB drives 845 and other types of drives for reading from and writing to flash memory devices (e.g., compact flash, memory stick/PRO and DUO, SD card, multimedia card, smart media card), and a scanner 858 for scanning items such as still image photographs to be downloaded to remote computer 812. A hard disk interface 852a, magnetic disk drive interface 854a, a optical drive interface 856a, a USB drive interface 845a, and a scanner interface 858a operate to connect bus 824 to hard disk drive 852, magnetic disk drive 854, optical disk drive 856, USB drive 845 and a scanner 858, respectively. Each of these drive components and their associated computer-readable media may provide remote computer 812 with non-volatile storage of computer-readable instruction, program modules, data structures, application programs, an operating system, and other data for the remote computer 812. In addition, it will be understood that remote computer 812 may also utilize other types of computer-readable media in addition to those types set forth herein, such as digital video disks, random access memory, read only memory, other types of flash memory cards, magnetic cassettes, and the like.

Remote computer 812 may operate in a networked environment using logical connections with image capture devices such as MRI, CT scanners, Ultrasound, Positron Emission Tomography (PET) or X-Ray devices. Network interface 828 provides a communication path 860 between bus 824 and network 820, which allows images to be communicated through network 820 from any of the previously identified imaging devices, and optionally saved in a memory, to the remote computer 812. This type of logical network connection is commonly used in conjunction with a local area network. Images may also be communicated from bus 824 through a communication path 862 to network 820 using serial port 832 and a modem 864. Using a modem connection between the remote computer 812 and imaging devices may be used in conjunction with a wide area network or the internet. It will be appreciated that the network connections shown herein are merely exemplary, and it is within the scope of the present invention to use other types of network connections between remote computer 812 and imaging devices including both wired and wireless connections.

The present invention provides a useful, novel and non-obvious means to utilize radiological domain ontology to validate, identify and classify radiological information. Additionally, the present invention provides a tool that may be utilized by other applications or systems as a building block for further information processing.

From the foregoing, it will be seen that this invention is one well adapted to attain all the ends and objectives hereinabove set forth together with other advantages which are obvious and which are inherent to the method and apparatus. It will be understood that certain features and sub-combinations are of utility and may be employed without reference to other features and sub-combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed, as the best mode contemplated for carrying out this invention, but that the invention will include all embodiments falling within the scope and spirit of the appended claims.

What is claimed is:

1. A method in a computing environment for consulting and providing response information from, a radiological domain ontology in reference to a subject, the method comprising:
defining one or more aspects of radiology functions as concept properties represented by a vocabulary of one or more instances of said radiological domain ontology, said radiological domain ontology declaring and fulfilling a model of radiological domain knowledge;
wherein said model of radiological domain knowledge comprises:
one or more findings;
one or more finding characteristics; and
object properties, wherein said object properties represent relationships among said findings and finding characteristics;
providing an informational item of interest that relates to said subject;
employing a context that defines a set of said domain knowledge and the relationships among said set of domain knowledge to describe said subject;
validating said informational item is radiological and resides in said domain of knowledge;
identifying definitive concept of said informational item from within said domain of knowledge; and
classifying said informational item.

2. The method of claim 1 wherein said classifying, identifies or defines said informational item as a finding or finding characteristic.

3. The method of claim 1 wherein the said provided response information from said radiological domain ontology is a list of all radiological findings for said model of radiological domain knowledge.

4. The method of claim 1 wherein the provided response information from said radiological domain ontology is a list of all radiological finding characteristics for said model of radiological domain knowledge.

5. The method of claim 1 wherein the provided response information from said radiological domain ontology is a list of all finding characteristics that apply to a given finding of claim 3.

6. The method of claim 1 further comprising validating that said informational item is within a specific radiological context.

7. The method of claim 1 further comprising adding a new radiological concept as an instance or instance expression to said radiological domain ontology.

8. The method of claim 1 further comprising, deleting an instance or instance expression of an existing radiological concept from said radiological domain ontology.

9. The method of claim 1 further comprising, providing a list of containers and container items, wherein a container is a characteristic concept and container items are individual finding characteristics that have applicability to a user interface for a given radiological finding concept.

10. The method of claim 1 wherein said information item is provided by a radiologist during the process of analyzing a patient X-ray.

11. A method in a computing environment for identifying, validating and classifying one or more radiological informational items, utilizing a radiological domain ontology in reference to a subject, the method comprising:
defining one or more aspects of radiological functions as concept properties represented by a vocabulary of one or more instances of said radiological domain ontology, said radiological domain ontology declaring and fulfilling a model of radiological domain knowledge;
receiving an informational item of interest that relates to said subject;
wherein said domain knowledge comprises:
a plurality of findings;
a plurality of finding characteristics; and
object properties, wherein said object properties represent relationships among said plurality findings and said plurality of finding characteristics;
employing a context that defines a set of said domain knowledge and the relationships among said set of domain knowledge to describe said subject;
wherein said validating determines that said informational item is radiological and resides in said domain knowledge;
wherein said identifying determines a definitive concept of said informational item from within said domain knowledge; and
wherein classifying said informational item determines that said informational item is one of said plurality of findings or one of said plurality of finding characteristics.

12. A computing system for identifying, validating and classifying one or more radiological informational items, utilizing a radiological domain ontology in reference to a subject comprising:
a definition of one or more aspects of radiology functions as concept properties represented by a vocabulary of one or more instances of said radiological domain ontology, said radiological domain ontology declaring and fulfilling a model of radiological domain knowledge;
means for receiving an informational item of interest that relates to said subject;
a context that defines a set of said domain knowledge and the relationships among said set of domain knowledge to describe said subject;
a validation module to determine that said informational item is radiological and resides in said domain knowledge;
an identification module to determine a definitive concept of said informational item from within said domain knowledge; and
a classification module for determining that an information item is a finding or a finding characteristic, within said domain knowledge;
wherein said domain knowledge comprises:
one or more findings;
one or more finding characteristics; and
object properties,
wherein said object properties represent relationships among said findings and finding characteristics.
